(19) United States
(12) Patent Application Publication
(10) Pub. No.: US 2005/0115347 A1
(43) Pub. Date: Jun. 2, 2005

(54) Speed reducer having hypoid gear

(75) Inventor: Tetsuo Takechi, Hannda-shi (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: SUMITOMO HEAVY INDUSTRIES, LTD.

(21) Appl. No.: 10/995,409

(22) Filed: Nov. 24, 2004

(30) Foreign Application Priority Data
Nov. 28, 2003 (JP) 2003-400609

(51) Int. Cl. F16H 1/06

(52) U.S. Cl. 74/423

(57) ABSTRACT

A slide pin (clutch shaft) of a clutch device is disposed in parallel with an intermediate shaft (hypoid shaft) and an output shaft. The slide pin has a slidable slide member. An output gear is driven on the output shaft together with the slide so as to connect and disconnect power transmission between the hypoid shaft and the output shaft.

### BACKGROUND OF THE INVENTION

1. Field of the Invention

The present invention relates to a speed reducer having a hypoid gear.

2. Description of the Related Art

A hypoid gear set comprising a hypoid pinion and a hypoid gear has the advantages that A) an extending direction of an output shaft is changeable to a direction orthogonal to an input shaft, B) a dimension in the axial direction of the output shaft is shortened, C) a certain speed reduction ratio is obtained only by the hypoid gear set, D) noise and vibration are lowered, and the like.

Conventionally, the publication of Japanese Patent No. 2760677 (hereinafter, referred to as “patent document 1”) discloses an example in which the hypoid gear set is applied to a speed reducer for a self-propelled carrier with the use of these advantages.

Briefly explaining about this speed reducer with reference to FIGS. 3 and 4, a speed reducer 10 used in a self-propelled carrier (an illustration of the whole carrier is omitted) comprises a hypoid reduction gear 12 and a DC motor 14 (only part of the motor is illustrated).

A hypoid pinion 16 is formed at an end of a motor shaft 14A of the DC motor 14 by cutting. The hypoid pinion 16 facing into the hypoid reduction gear 12 is engaged with a hypoid gear 18.

An intermediate pinion 22 is slidably integrated with a hypoid shaft 20, to which the hypoid gear 18 is attached. The intermediate pinion 22 is engaged with an output gear 24, which is integrated with an output shaft 23.

In the drawings, the reference numeral 25 refers to a clutch device. When an operator operates a handle 26, the intermediate pinion 22 is moved along the hypoid shaft 20 through the engagement between a pin 21 and a recessed section 22A to enable the connection and disconnection of power transmission between the hypoid shaft 20 and the intermediate pinion 22 by the disengagement and engagement of splines 22B.

Thus, when the self-propelled carrier is manually driven especially in the event of a power failure, breakdown in a motor, or the like, it is possible to reduce a traction load.

By the way, this self-propelled carrier itself moves in predetermined orbit by the rotation of not-illustrated wheels, in a state that an object to be carried is mounted or suspended thereon. Thus, from the viewpoint of its property, it is necessary to secure “space without any obstruction” on the periphery of the orbit spreading the whole section of the orbit. The “space without any obstruction” has to be larger than a projected area in a traveling direction of the carrier (an outermost outline of a figure illustrated in FIG. 4). Therefore, when the projected area in the traveling direction of the speed reducer 10 is large, the self-propelled carrier itself cannot be installed. Also, it becomes impossible to take advantage of space around the orbit for another object.

Accordingly, in the speed reducer 10 for the self-propelled carrier, which is disclosed in the foregoing patent document 1, the hypoid gear set comprising the hypoid pinion 16 and the hypoid gear 18 is installed in part of a speed reduction mechanism. The direction of the motor shaft 14A of the motor 14 is turned 90 degrees, and the motor 14 extended in the axial direction is installed in a direction along a traveling direction X so as to prevent the projected area in the traveling direction of the carrier from enlarging due to the motor 14.

By using the function of the hypoid gear set, that is, “a dimension in the axial direction of the output shaft can be shortened,” a dimension S in a horizontal direction of the projected area of a reduction gear section is particularly downsized. At the same time, by using the function that “the hypoid gear set can secure a certain speed reduction ratio by itself,” the hypoid gear set is actively used for securing the speed reduction ratio. Furthermore, low noise and low vibration properties make it possible to quietly carry the object to be carried without damage.

As described in this application example, since the hypoid gear set has many advantages that a general gear pair mechanism with parallel axes, a bevel gear mechanism, and the like cannot obtain, there are deep-seated needs of the hypoid gear set particularly in the field requiring miniaturization, weight reduction, low noise, low vibration, and the like.

According to the technology disclosed in the patent document 1, however, the intermediate pinion 22 moves along the hypoid shaft 20 (a shaft to which the hypoid gear is attached) to structure the clutch device 25.

Thus, the intermediate pinion 22 has to be provided with the recessed section 22A and the spline 22B while securing a certain degree of strength, so that a pitch circle diameter cannot help suitably enlarging. Therefore, a speed reduction ratio obtained between the intermediate pinion 22 and the output gear 24 becomes small. As a result, there is a problem that a total speed reduction ratio of the reduction gear 12 cannot help lowering.

Accordingly, in the case of an application requiring a higher speed reduction ratio, another stage of gear pair mechanism with parallel axes has to be installed in the reduction gear, or the distance between the center of the hypoid shaft 20 and the center of the output shaft 23 has to be enlarged to enlarge the diameter of the output gear 24. The reduction gear becomes large and heavy in any method so that there is a problem that the miniaturization and weight reduction of the reduction gear are impaired irrespective of “the introduction of the hypoid gear set.”

In the clutch device 25 disclosed in the foregoing patent document 1, the intermediate pinion 22 is manually driven in both of the axial directions. In regard to, for example, the operation of returning the clutch, if spring force or the like is used to return the clutch with light force, convenience is further improved. In this case, however, it is difficult to install such energizing member in the hypoid shaft 22 without increasing a dimension in the axial direction of the output shaft.

### SUMMARY OF THE INVENTION

In view of the foregoing problems, various exemplary embodiments of this invention provide a speed reducer with a hypoid gear, in which a clutch device is installed without impairing the conventional functions of the hypoid gear as possible as it can, and which realizes a certain level of a high speed reduction ratio without increasing the number of speed reduction stages. Furthermore, even when energizing member is installed in the speed reducer to ease the return of a clutch as necessary, a dimension in the direction of an output shaft is not increased.

To achieve the foregoing object, according to one of the various exemplary embodiments of the present invention, a speed reducer with a hypoid gear comprises: a hypoid shaft with which the hypoid gear is integrated; an intermediate pinion integrated with the hypoid shaft; an output shaft disposed in parallel with the hypoid shaft; an output gear slidably integrated with the output shaft and being engageable with the intermediate pinion; a clutch shaft disposed in parallel with the hypoid shaft and the output shaft; and a clutch device having a slide member slidably disposed on the clutch shaft, the clutch device being capable of driving the output gear on the output shaft together with a slide of the slide member and of connecting and disconnecting power transmission between the output gear and the output shaft or between the output gear and the intermediate pinion.

The present invention focuses attention on the fact that miniaturization is the most required in the axial direction of the output shaft, as described in the foregoing example, in an application to which the speed reducer with the hypoid gear is applied. As the clutch device is installed in the speed reducer with the hypoid gear, the clutch shaft, which is disposed in parallel with the hypoid shaft and the output shaft, is newly provided.

Thus, the intermediate pinion (composing part of a gear pair mechanism with parallel axes in the latter stage), which is attached to the hypoid shaft, does not need to have any function related to the clutch device (a recessed section 22A, a spline 22B, and the like) so that it becomes possible to reduce a pitch circle diameter of the intermediate pinion. Thus, it becomes possible to secure a high speed reduction ratio of the gear pair mechanism with parallel axes, which is composed of the intermediate pinion and the output gear, without enlarging the pitch circle diameter of the output gear. As a result, it is possible to secure a higher speed reduction ratio while keeping the number of speed reduction stages at two.

Since the clutch shaft is newly provided in the present invention, increase in the number of shafts similarly means increase in the number of the speed reduction stages. In adding an intermediate shaft belonging to a power transmission system, however, the intermediate shaft deals with torque much more than torque which the clutch shaft deals with. Thus, bearings corresponding to the high torque have to be disposed when the intermediate shaft is added, and hence a degree of increase in cost is totally different. The effect of not needing to increase another speed reduction stage for securing the speed reduction ratio according to the present invention is extremely beneficial realistically.

In the present invention, such energizing member as to easily return the clutch, as described later on, is not always necessary. If such member is provided, however, the energizing member can be attached to the clutch shaft with allowance so that it is possible to certainly prevent a dimension in the axial direction of the output shaft from increasing.

Furthermore, in this relation (relating to the fact that the clutch shaft deals with little torque because the clutch shaft does not contribute to power transmission), it is possible to easily dispose the clutch shaft in any position of the speed reducer. Therefore, particularly considering the ease of clutch operation by an operator, the clutch device can be easily disposed in the most appropriate position of the speed reducer.

According to the various exemplary embodiments of the present invention, it is possible to easily provide the clutch device in an approximately arbitrary position while preventing increase in length in the axial direction of the output shaft, on which prime importance is placed in the speed reducer with the hypoid gear. At the same time, it becomes possible to secure the high speed reduction ratio of the whole speed reducer.

### BRIEF DESCRIPTION OF THE DRAWINGS

Various exemplary embodiments of the present invention will be described in detail with reference to the accompanying drawings, wherein:

FIG. 1 is a partly broken front view of an exemplary embodiment of a hypoid speed reducer, to which the present invention is applied;

FIG. 2 is a sectional view taken along the line II-II in FIG. 1;

FIG. 3 is a front sectional view showing an example of the configuration of a conventional hypoid speed reducer; and

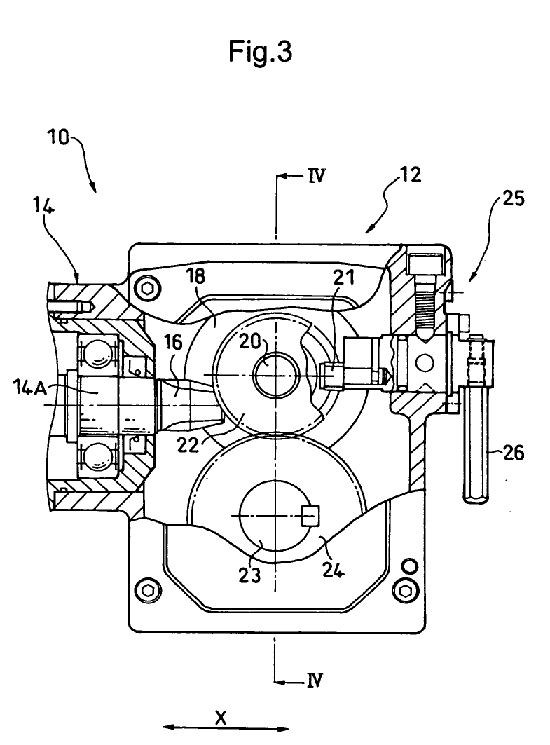

FIG. 4 is a sectional view taken along the line IV-IV in FIG. 3.

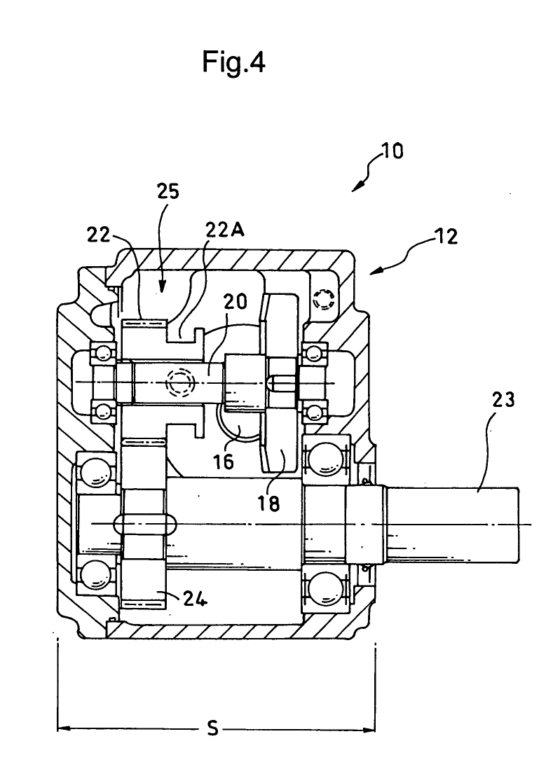

### DETAILED DESCRIPTION OF THE PREFERRED EMBODIMENT

Various exemplary embodiments of this invention will be hereinafter described in detail with reference to the drawings.

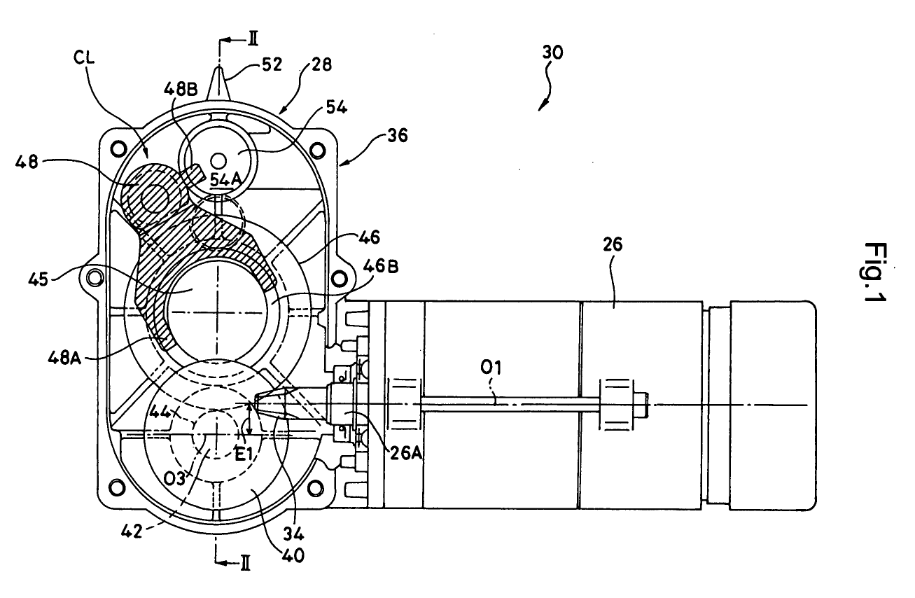

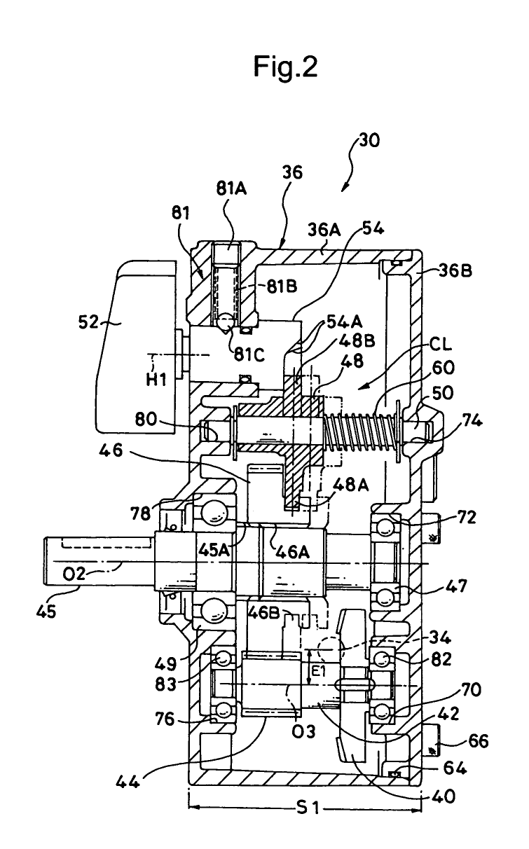

FIG. 1 is a partly broken front view of a speed reducer having a hypoid gear to which the present invention is applied, and FIG. 2 is a longitudinal sectional view of FIG. 1.

Referring to FIGS. 1 and 2, a hypoid speed reducer 30 comprises a DC motor 26 and a hypoid reduction gear 28. The center O1 of a motor shaft 26A of the DC motor 26 is disposed in a direction orthogonal (not intersecting) to the center O2 of an output shaft 45, and the hypoid reduction gear 28 changes the rotation direction of the DC motor 26 by 90 degrees.

A hypoid pinion 34 is formed at an end of the motor shaft 26A of the DC motor 26 by cutting. The hypoid pinion 34 facing into a casing 36 of the hypoid reduction gear 28 is engaged with a hypoid gear 40. In other words, the motor shaft 26A of the DC motor 26 also functions as an input shaft of the hypoid reduction gear 28 in this exemplary embodiment. In a plan view, the center O1 of the hypoid pinion 34 (that is, the center of the motor shaft 26A) is orthogonal to the center O3 of an intermediate shaft (hypoid shaft) 42, to which the hypoid gear 40 is attached, at a shift amount E1 away.

A second stage pinion (intermediate pinion) 44 is formed in the intermediate shaft 42. The second stage pinion 44 is engaged with an output gear 46, which is slidably attached to the output shaft 45. The output shaft 45 is disposed in parallel with the intermediate shaft 42 (namely, orthogonally to the motor shaft 26A) through bearings 47 and 49. A male spline (external gear) 45A is formed in a part of the outer periphery of the output shaft 45. On the other hand, a female spline 46A, which is engageable with the male spline 45A, is formed in the inner periphery of the output gear 46. In other words, the output gear 46 is an internal gear engaged with the male spline 45A, while it is the external gear engaged with the second stage pinion 44. The output shaft 45 is coupled to an input shaft of a not-illustrated driven member to drive the driven member.

Next, a clutch mechanism (clutch device) CL will be described.

The output gear 46 has a ring-shaped recessed section 46B in a part of its outer periphery. An engagement section 48A of a slide member 48 is engaged in the recessed section 46B. The slide member 48 is slidable along a slide pin (clutch shaft) 50, which is separately disposed in parallel with the output shaft 45. This slide member 48 has a pin 48B on the opposite side of the engagement section 48A (an upper side in FIG. 2).

A handle (knob) 52 is provided with an eccentric cam 54, which rotates integrally with the handle 52 about the central axis H1 of the handle 52. This eccentric cam 54 has a cam surface 54A. The cam surface 54A can rotate about the central axis H1 in accordance with the rotation of the handle 52, and the pin 48B of the slide member 48 is pushed by the rotation of the cam surface 54A. The slide member 48 is movable only along the slide pin 50, so that propulsive force (a component of force) of the slide member 48 in the direction of the slide pin 50 is obtained by pushing force from the pin 48B. The slide member 48 is always biased toward a left direction in FIG. 2 (the direction of engaging the female spline 46A of the output gear 46 with the male spline 45A of the output shaft 45) by a spring (energizing member) 60 attached to the slide pin 50.

The clutch mechanism CL, which can connect and disconnect the power transmission between the output gear 46 and the output shaft 45, comprises the slide pin (clutch shaft) 50 as a center, the handle 52, the eccentric cam 54, the spring 60, the slide member 48, the female spline 46A of the output gear 46, and the male spline 45A of the output shaft 45.

The casing 36 of the hypoid reduction gear 28, on the other hand, mainly comprises a main body 36A and a cover 36B, which are integrated with bolts 66 through a seal ring 64. The cover 36B has support holes 70, 72, and 74, which support respective shafts in the hypoid reduction gear 28, that is, the intermediate shaft 42, the output shaft 45, and the slide pin 50. The main body 36A of the casing 36 has support holes 76, 78, and 80, which correspond to the support holes 70, 72, and 74. The intermediate shaft 42 is rotatably supported by the support holes 70 and 76 through bearings 82 and 83. The output shaft 45 is rotatably supported by the support holes 72 and 78 through the bearings 47 and 49. The slide pin 50 is rotatably supported by the support holes 74 and 80 directly, because large torque is not applied to the slide pin 50.

The reference numeral 81 refers to an alignment mechanism of the eccentric cam 54, which comprises a bolt 81A, a spring 81B, and a ball 81C. The alignment mechanism 81 restrains the movement of the eccentric cam 54 in the direction of the central axis H1.

Then, the operation of the hypoid speed reducer 30 according to this exemplary embodiment will be described.

When the motor shaft 26A of the DC motor 26 rotates, the hypoid pinion 34 formed at the end of the motor shaft 26A integrally rotates. When the hypoid pinion 34 rotates, the hypoid gear 40 engaged with the hypoid pinion 34 rotates, and the second stage pinion 44 formed in the intermediate shaft 42 rotates. The rotation of the second stage pinion 44 is transmitted to the output gear 46.

During normal use, the position of the handle (knob) 52 fixes the slide member 48 in a position shown by solid lines in FIG. 2 by use of the function of the spring 60. Thus, the female spline 46A of the output gear 46 is engaged with the male spline 45A of the output shaft 45, and therefore, the rotation of the output gear 46 becomes the rotation of the output shaft 45 as is.

On the other hand, when it becomes necessary to manually drive the driven member for some reason, namely, when torque is inputted from the output shaft 45, large drive resistance occurs if the output shaft 45 is coupled to the motor shaft 26A through the second stage pinion 44, the hypoid gear 40, and the hypoid pinion 34. Therefore, in this case, the handle 52 is rotated to rotate the cam surface 54A of the eccentric cam 54 about the central axis H1. Since this rotation gives a component of force in the axial direction of the slide pin 50 via the pin 48B of the slide member 48, the slide member 48 slides in a right direction in FIG. 2 against a biasing force of the spring 60, and the output gear 46 is moved together in the right direction in FIG. 2 via the engagement section 48A. As a result, the engagement between the female spline 46A of the output gear 46 and the male spline 45A of the output shaft 45 is released, and the output shaft 45 gets out of a power transmission system from the DC motor 26. Therefore, an operator can easily drive or move the driven member due to the existence of the clutch mechanism CL.

In this exemplary embodiment, the clutch mechanism CL is configured such that the output gear 46 having the female spline 46A slides along the output shaft 45 with respect to the male spline 45A formed in the output shaft 45, to engage and disengage the male spline 45A and the female spline 46A. Therefore, the structure of the clutch mechanism CL itself is simple so that it is possible to realize cost reduction of the entire speed reducer.

Furthermore, the slide of the output gear 46 along the output shaft 45 is realized by the slide member 48, which is slidable on the slide pin (clutch shaft) 50 disposed in parallel with the intermediate shaft (hypoid shaft) 42 and the output shaft 45. Thus, it is possible to effectively use space with more allowance, and it is possible to prevent increase in a dimension S1 in the axial direction of the output shaft even when the clutch device CL with a return mechanism is provided.

Since the clutch device CL is not provided on the side of the intermediate shaft 42, it is possible to minimize the pitch circle diameter of the second stage pinion (intermediate pinion) 44 to approximately its limit, which is desired to be as small as possible for obtaining a high speed reduction ratio. Therefore, it is possible to easily adapt to the high speed reduction ratio without adding another speed reduction stage or without further enlarging the output gear 46, the diameter of which is originally large.

In the foregoing exemplary embodiment, the power transmission between the output shaft 45 and the output gear 46 is connected and disconnected by moving the output gear 46. However, by releasing the engagement between the output gear and the intermediate pinion, the power transmission between the output gear and the intermediate pinion may be connected and disconnected.

In the foregoing exemplary embodiment, the hypoid pinion is directly formed in the motor shaft, and the motor shaft also functions as the input shaft of the reduction gear. The present invention, however, is applicable to a case where an independent input shaft is provided in a reduction gear and a hypoid pinion is disposed on the input shaft, as a matter of course.

Furthermore, energizing member for returning a clutch is not always necessary in the present invention. The operator may manually drive the clutch in both of a connection direction and a disconnection direction.

The speed reducer is beneficial in an application requiring the functions of the hypoid reduction gear, as a speed reducer which especially needs the installation of the clutch device, and is expected to prevent increase in dimension in the axial direction of the output shaft and to secure the high speed reduction ratio.

The disclosure of Japanese Patent Application No. 2003-400609 filed Nov. 28, 2003 including specification, drawing and claim are incorporated herein by reference in its entirety.

1. A speed reducer with a hypoid gear comprising:
a hypoid shaft with which the hypoid gear is integrated;
an intermediate pinion integrated with the hypoid shaft;
an output shaft disposed in parallel with the hypoid shaft;
an output gear slidably integrated with the output shaft and being engageable with the intermediate pinion;
a clutch shaft disposed in parallel with the hypoid shaft and the output shaft; and
a clutch device having a slide member slidably disposed on the clutch shaft, the clutch device being capable of driving the output gear on the output shaft together with a slide of the slide member and of connecting and disconnecting power transmission between the hypoid shaft and the output shaft.

2. The speed reducer with a hypoid gear according to claim 1, wherein
the clutch device is capable of connecting and disconnecting power transmission between the output gear and the output shaft.

3. The speed reducer with a hypoid gear according to claim 1, wherein
the clutch device is capable of connecting and disconnecting power transmission between the output gear and the intermediate pinion.

4. The speed reducer with a hypoid gear according to claim 1, wherein
the clutch device has energizing member on the clutch shaft, the energizing member forcing the slide member toward one direction.

5. The speed reducer with a hypoid gear according to claim 1, wherein
the clutch device comprises an eccentric cam, and a propulsive force of the slide member in an axial direction is obtained by a slide between the eccentric cam and the slide member.
